(19) United States
(12) Patent Application Publication
(10) Pub. No.: US 2024/0140153 A1
(43) Pub. Date: May 2, 2024

(54) SYSTEM AND METHOD FOR TONGUE WEIGHT SENSING AND TRAILER BRAKE GAIN

(71) Applicant: Hall Logic, Inc., Provo, UT (US)

(72) Inventors: Michael Hall, Provo, UT (US); Thomas Corie, Springville, UT (US)

(73) Assignee: Hall Logic, Inc., Provo, UT (US)

(21) Appl. No.: 18/499,061

(22) Filed: Oct. 31, 2023

Related U.S. Application Data
(60) Provisional application No. 63/381,703, filed on Oct. 31, 2022.

(51) Int. Cl. B60D 1/24; B60D 1/28

(52) U.S. Cl. CPC B60D 1/248; B60D 1/28

(57) ABSTRACT

A vehicle may include a passenger compartment, one or more vehicle controls in the passenger compartment, a user interface in the passenger compartment, and a trailer hitch towards the rear end of the vehicle. The vehicle may include an accelerometer and a vehicle control unit (VCU). The accelerometer may output a signal in response to a change in pitch of the vehicle as a trailer is attached to the vehicle at the trailer hitch. The VCU may have a memory device and a processing device. The processing device may: determine the change in the pitch of the vehicle; determine a tongue weight of the trailer based on the change in the pitch; compare the tongue weight to a threshold tongue weight; and, in response to the tongue weight being greater than the threshold tongue weight, output a warning indicator via the vehicle's user interface.

### RELATED APPLICATIONS

This application claims priority to pending U.S. Provisional Application No. 63/381,703, filed Oct. 31, 2022, entitled SYSTEM AND METHOD FOR TONGUE WEIGHT SENSING AND TRAILER BRAKE GAIN, the entire disclosure of which is incorporated herein by reference.

### BACKGROUND

Various vehicles, including passenger vehicles such as cars, trucks, and/or sport utility vehicles, are used to tow trailers. Trailers serve a variety of purposes; some are used for work purposes such as to tow loads of materials or work equipment, while others are used for recreation purposes such as to tow recreational vehicles. Trailers may have different and/or variable load capacities, and the particular weight of a load may not be known. Indeed, the same vehicle and trailer may be used to tow loads of various different weights. Information about how a trailer is loaded may be useful to ensure safe towing.

One system is described in U.S. Pat. No. 10,994,715, entitled AUTO GAIN ADJUSTING TRAILER BRAKE CONTROLLER, the entire disclosure of which is incorporated herein by reference.

### SUMMARY OF THE INVENTION

In one aspect, the invention is a vehicle, with a passenger compartment wherein a passenger of the vehicle sits to operate the vehicle. The vehicle also has one or more vehicle controls in the passenger compartment whereby the passenger operates the vehicle. The vehicle also includes a user interface in the passenger compartment positioned to be visible by the passenger. A trailer hitch is located towards a rear end of the vehicle. An accelerometer outputs a signal in response to a change in a pitch of the vehicle as a trailer is attached to the vehicle at the trailer hitch. The accelerometer is positioned in the passenger compartment, behind a dashboard of the passenger compartment, or towards the rear end of the vehicle and closer to the trailer hitch than the dashboard. A vehicle control unit (VCU) is electronically or communicatively coupled to the accelerometer. The VCU includes a memory device having computer-readable instructions stored thereon and a processing device electronically or communicatively coupled to the memory device that executes the instructions. As the processing device executes the instructions, it determines the change in the pitch of the vehicle in response to detecting the signal from the accelerometer, with the change in the pitch of the vehicle being caused by a trailer being attached to the trailer hitch. The processing device also determines a tongue weight of the trailer based on the change in the pitch and a set of vehicle parameters, which set of vehicle parameters includes a position of the trailer hitch on the vehicle and a stiffness of a rear and a front suspension of the vehicle. The processing device also compares the tongue weight to a threshold tongue weight. The threshold tongue weight represents a maximum tongue weight for the vehicle. In response to the tongue weight being greater than the threshold tongue weight, the processing device outputs a warning indicator via the user interface.

In another aspect, the invention is a method of calibrating a tongue weight sensing system. The method includes the step of receiving, via a user interface, a set of calibration parameters for calibrating the tongue weight sensing system. The calibration parameters include vehicle identification data for a vehicle with which the tongue weight sensing system is used. In turn, the vehicle identification data include one or more of a vehicle identification number, a make of the vehicle, a model of the vehicle, and a year of the vehicle. The calibration parameters also include a weight of a calibration object used to calibrate the tongue weight sensing system and a calibration position on the vehicle where the calibration object will be set on the vehicle. The method also includes the step of generating a start signal that prompts a user to set the calibration object on the vehicle at the calibration position. The method further includes the step of receiving, from an accelerometer attached to the vehicle, a calibration signal that indicates a change in a pitch of the vehicle as the calibration object is set on the vehicle, with the pitch signal including a data series corresponding to the change in the pitch. The method also includes the step of determining, based on the data series of the pitch signal, suspension characteristics of the vehicle. The suspension characteristics include one or more of a stiffness of a suspension of the vehicle, a natural frequency of the suspension, and a damper of the suspension. The method still further includes the step of comparing the vehicle identification data to a vehicle database to determine whether the vehicle database contains a data set corresponding to the vehicle.

If the vehicle database contains the data set corresponding to the vehicle, the method then compares the suspension characteristics of the vehicle to the data set and determines whether the suspension characteristics fall within a threshold range for the data set.

If, the suspension characteristics of the vehicle are within the threshold range, the suspension characteristics are added to the data set. If the suspension characteristics fall outside the threshold range, a recalibration signal is generated that prompts the user to recalibrate the tongue weight sensing system. The method then includes the steps of receiving recalibrated suspension characteristics of the vehicle and determining whether the recalibrated suspension characteristics fall within the threshold range for the data set.

If the recalibrated suspension characteristics of vehicle are within the threshold range, the recalibrated suspension characteristics are added to the data set.

If the recalibrated suspension characteristics fall outside the threshold range, a unique vehicle profile is created comprising the recalibrated suspension characteristics, wherein the unique vehicle profile is unique to the vehicle.

If the vehicle database does not contain the data set corresponding to the vehicle, a profile for the vehicle is created in the vehicle database, wherein the profile for the vehicle is correlated to the make, the model, and the year of the vehicle.

In yet another aspect, the invention is a system that determines an autogain for a trailer brake. The system includes a trailer wire connector that couples a vehicle electrical system to a trailer power line and a power analyzer electrically coupled to the trailer wire connector, wherein the power analyzer measures a impedance from the trailer power line. The system also includes a vehicle control unit (VCU) electronically or communicatively coupled to the power analyzer. The VCU includes a memory device having computer-readable instructions stored thereon and a processing device electronically or communicatively coupled to the memory device that executes the instructions. As the processing device executes the instructions, it (1) determines a trailer weight, (2) determines, based on a signal output by the power analyzer, the impedance of the trailer power line, (3) determines, based on the impedance, a type of the trailer brake, (4) generates, based on the trailer weight and the type of the trailer brake, a gain signal for the trailer brake, and (5) transmits the gain signal to the trailer brake via the trailer wire connector.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 illustrates a vehicle with a tongue weight sensing system, according to one embodiment.

FIG. 2 illustrates a passenger compartment of a vehicle with a tongue weight sensing system, according to another embodiment.

FIG. 3 illustrates a network layout of a tongue weight sensing system, according to another embodiment.

FIG. 4 illustrates a system diagram of various elements of a tongue weight sensing and trailer brake autogain system, according to another embodiment.

FIG. 5 illustrates a method of determining and using a tongue weight, according to one embodiment.

FIGS. 6A and 6B illustrate a method of crowdsourcing calibration parameters for a tongue weight sensing system, according to another embodiment.

FIG. 7 illustrates a method of setting a trailer brake autogain, according to one embodiment.

FIG. 8 illustrates a method of generating a gain signal for a trailer brake, according to one embodiment.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

Systems and methods for tongue weight sensing and trailer brake gain as disclosed herein will become better understood through a review of the following detailed description in conjunction with the figures. The detailed description and figures provide merely examples of the various embodiments of systems and methods for tongue weight sensing and trailer brake gain. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

A vehicle may have various limits to its towing capabilities. For example, a vehicle may have a limit to how much weight it can tow, the payload it can carry or tow based on characteristics of the vehicle's suspension, and/or a powertrain or drivetrain design of the vehicle. Typically, drivers would rely on published values for tongue weight and payload, and/or the weight of a trailer. Drivers may also resort, in some cases, to using the “eyeball” method. a trailer would be attached to a vehicle and the driver would look at the vehicle's suspension to see how much the suspension was compressed. However, these methods are often unreliable and result in inaccurately estimating the actual tongue weight or payload of a trailer.

Embodiments of the systems and methods described below may address some or all of the problems described above. A vehicle may include a passenger compartment, one or more vehicle controls in the passenger compartment, a user interface in the passenger compartment, and a trailer hitch towards the rear end of the vehicle. A passenger of the vehicle may sit in the passenger compartment to operate the vehicle using the one or more vehicle controls. Passenger may also interact with various vehicle systems via the user interface. The vehicle systems may include an accelerometer and a vehicle control unit (VCU). The accelerometer may output a signal in response to a change in pitch of the vehicle as, for example, a trailer is attached to the vehicle at the trailer hitch. The accelerometer may be positioned in a passenger compartment, behind a dashboard of the passenger compartment, or towards the rear end of the vehicle, closer to the trailer hitch than to the dashboard. The VCU may have a memory device and a processing device. Computer readable instructions may be stored on the memory device. The processing device may be electronically or communicatively coupled to the memory device. The processing device may execute the instructions stored on the memory device. As the processing device executes the instructions, it may: determine the change in the pitch of the vehicle; determine a tongue weight of the trailer based on the change in the pitch; compare the tongue weight to a threshold tongue weight; and, in response to the tongue weight being greater than the threshold tongue weight, output a warning indicator via the vehicle's user interface. The processing device may determine the change in the pitch of the vehicle in response to detecting a signal from the accelerometer. The change in the pitch of the vehicle may be due to a trailer being attached to the trailer hitch. The tongue weight of the trailer may be determined based on the change in the pitch and a set of vehicle parameters. The set of vehicle parameters may include a position of the trailer hitch on the vehicle, vehicle wheelbase, and a stiffness of a rear and a front suspension of the vehicle. The threshold tongue weight may represent a maximum tongue weight the vehicle can support.

Using the methods and systems described herein, a vehicle driver can know more precisely the tongue weight of the trailer. Additionally, the tongue weight may be used to set the auto gain of the trailer brake more accurately. With this information, the vehicle may be operated more safely.

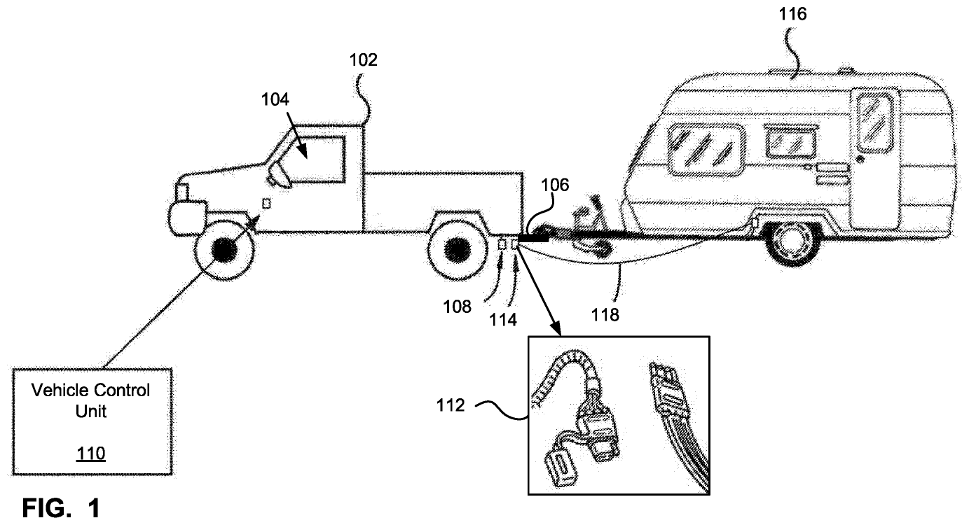

FIG. 1 illustrates a vehicle 102 with a tongue weight sensing system, according to one embodiment. The tongue weight sensing system may be integrated into the vehicle during manufacturing of the vehicle. The tongue weight sensing system may be added as an aftermarket feature. The tongue weight sensing system may be used to determine an autogain for a trailer brake.

The vehicle 102 they include a passenger compartment 104 where in the passenger of the vehicle 102 sits to operate the vehicle 102. The vehicle 102 may include a trailer hitch 106. The trailer hitch 106 may be positioned towards a rear end of the vehicle 102. For example, the trailer hitch 106 may be positioned at or connected to a rear bumper of the vehicle 102. The trailer hitch 106 may be positioned behind a rear axle of the vehicle 102. In some embodiments, the vehicle 102 may be a truck with a bed. The trailer hitch 106 may be positioned in the bed of the truck. The trailer hitch 106 may be positioned above the rear axle of the vehicle 102. The trailer hitch 106 may be positioned slightly in front of the rear axle of the vehicle 102.

The vehicle 102 may include an accelerometer 108. The accelerometer 108 may output a signal in response to a change in a pitch of the vehicle 102. The pitch of the vehicle 102 may change for a variety of reasons. For example. The pitch of the vehicle 102 may change as the vehicle is being driven due to terrain or road conditions. While the vehicle 102 is stationary, the pitch of the vehicle 102 may change due to a payload being added to the vehicle 102. The payload may, for example, be one or more passengers. The payload may be a trailer, such as trailer 116. Thus, the accelerometer 108 may output a signal indicating a change in a pitch of the vehicle due to the trailer 116 being hitched to the vehicle 102. The accelerometer may be positioned in the passenger compartment 104, behind a dashboard in the passenger compartment 104, or towards the rear end of the vehicle, closer to the trailer hitch 106 than the dashboard.

The accelerometer 108 may be electronically or communicatively coupled to the vehicle control unit (VCU) 110. For example, the accelerometer 108 and the VCU 110 may be part of the same integrated circuit. The accelerometer 108 may be a separate unit from the VCU 110 and may be coupled to the VCU 110 via the vehicle's 102 CANBUS. The VCU 110 may communicate with an electrical system of the trailer 116, such as the trailer's 116 brakes. The trailer's 116 electrical system may be coupled to the vehicle's 102 electrical system by a trailer wire connector 112. A power analyzer 114 may be electrically coupled to the trailer wire connector 112, the VCU 110, and a trailer power line 118. Similar to the accelerometer 108, the power analyzer 114 may be part of the same integrated circuit as the VCU 110, or may be positioned separately from the VCU 110. The power analyzer 114 may communicate with the VCU 110 via the vehicle's 102 CANBUS.

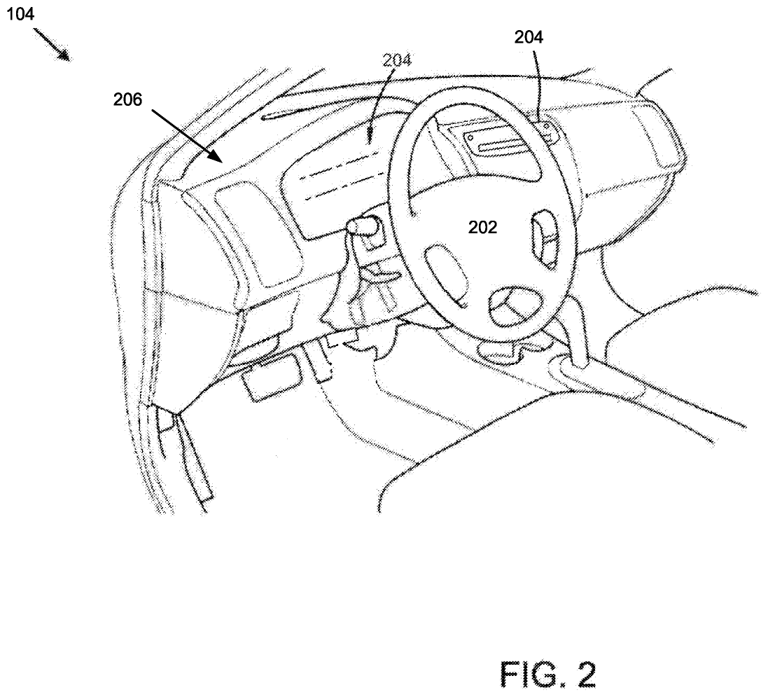

FIG. 2 illustrates a passenger compartment 104 of a vehicle with a tongue weight sensing system, according to one embodiment. One or more vehicle controls 202 may be housed within the passenger compartment 104. Such controls 202 may include, for example, a steering wheel, a brake pedal, a gas pedal, a shifter, and so forth. One or more user interfaces 204 may also be housed within the passenger compartment 104. Such user interfaces 204 may, for example, be integrated into a dashboard 206 within the passenger compartment 104. In some embodiments, the user interface 204 may be a tablet or smartphone that may be removed from the passenger compartment 104.

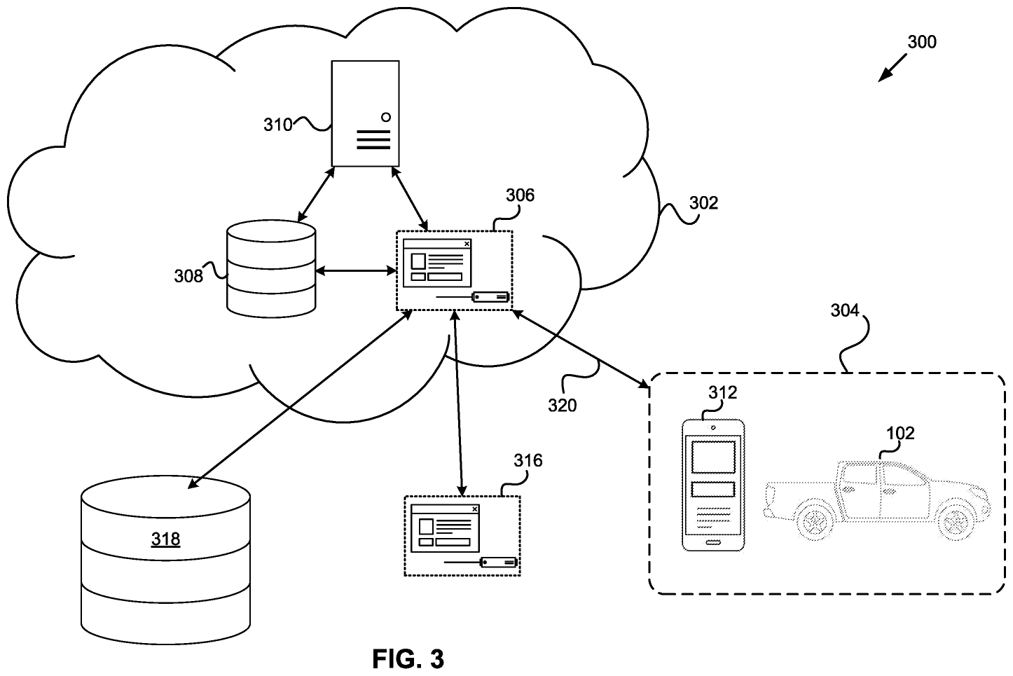

FIG. 3 illustrates a network layout of a tongue weight sensing system 300, according to one embodiment. The tongue weight sensing system 300 may include internal and external data resources that are used in the system to determine tongue weight or trailer brake gain. The tongue weight sensing system 300 may include a cloud-based data management and processing system 302 and a user device 304. The cloud-based data management and processing system 302 may include an application server 306, a database 308, and a data server 310. The user device 304 may include one or more devices and/or vehicles associated with user profiles of the tongue weight sensing system 300, such as a smartphone 312 and/or the vehicle 102, including elements of the vehicle such as the VCU, the user interface, the accelerometer, the power analyzer, and so forth. The user device 304 may also include a trailer and/or various systems of the trailer, such as a trailer brake and/or a trailer brake controller.

The tongue weight sensing system 300 may include external resources such as an external application server 316 and/or an external database 318. The various elements of the tongue weight sensing system 300 may communicate via various communication links 320. An external resource may generally be considered a data resource owned and/or operated by an entity other than an entity that utilizes the cloud-based data management and processing system 302 and/or the user device 304.

The tongue weight sensing system 300 may be web-based. The user device 304 may access the cloud-based data management and processing system 302 via an online portal set up and/or managed by the application server 306. The tongue weight sensing system 300 may be implemented using a public internet. The tongue weight sensing system 300 may be implemented using a private intranet. Elements of the tongue weight sensing system 300, such as the database 308 and/or the data server 310, may be physically housed at a location remote from an entity that owns and/or operates the tongue weight sensing system 300. For example, various elements of the tongue weight sensing system 300 may be physically housed at a public service provider such as a web services provider. Elements of the tongue weight sensing system 300 may be physically housed at a private location, such as at a location occupied by the entity that owns and/or operates the tongue weight sensing system 300.

The communication links 320 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 320, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long-term evolution (LTE) standard, and so forth. “Indirect,” when used regarding the communication links 320, may refer to any of the aforementioned indirect communication links.

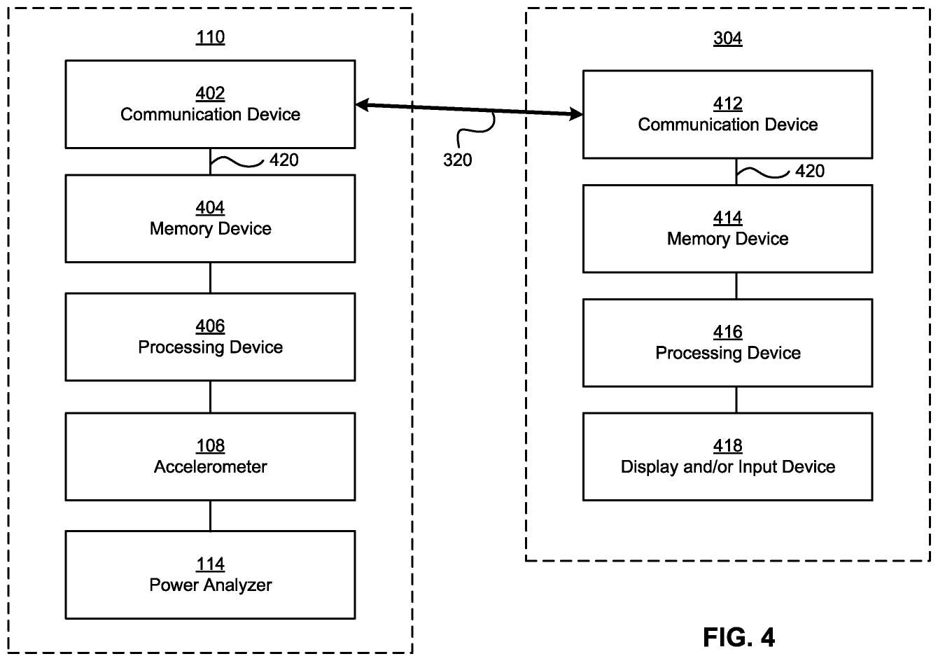

FIG. 4 illustrates a system diagram 400 of various elements of a tongue weight sensing and trailer brake autogain system, according to one embodiment. The VCU 110 may obtain and/or generate information and data that is communicated to the user interface 304. The VCU 110 may include a communication device 402, a memory device 404, and a processing device 406. The VCU 110 may include an integrated circuit with one or more of a variety of other control units integrated therewith. For example, the VCU 110 may include the accelerometer 108 and the power analyzer 114. In various embodiments, the accelerometer 108 and/or the power analyzer 114 may be separate from the VCU 110. Such components may, for example, communicate with the VCU over the vehicles CANBUS.

The user interface 304 may include a communication device 412, a memory device 414, a processing device 416, and a display and/or input device 418. Various hardware elements within the VCU 110 and/or the user interface 304 may be interconnected via a system bus 420. The system bus 420 may be and/or include a control bus, a data bus, and address bus, and so forth. The communication device 402 of the VCU 110 may communicate with the communication device 412 of the user interface 304. The communication device 402 of the VCU 110 may communicate with the communication device 412 of the user interface 304 via one or more communication links 320.

Various of the elements of the tongue weight sensing and trailer brake autogain system may include data storage and/or processing capabilities. Such capabilities may be rendered by various electronics for processing and/or storing electronic signals. A processing device may have volatile and/or persistent memory. A memory device may have volatile and/or persistent memory. The processing device may have volatile memory and the memory device may have persistent memory. Memory in the processing device may be allocated dynamically and may be based on instructions stored in the memory device.

The processing device may generate an output based on an input. For example, the processing device may receive an electronic analog and/or digital signal, such as a signal from the accelerometer 108 and/or a signal from the power analyzer 114. The processing device may read the signal and perform one or more tasks with the signal, such as performing various functions with data in response to input received by the processing device. The processing device may read from the memory device information needed to perform the functions. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

Various of the devices described herein may include data communication capabilities, as, for example, represented by the communication device 402 and the communication device 412. Such capabilities may be rendered by various electronics for transmitting and/or receiving electronic and/or electromagnetic signals. A communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

As used and described herein, a server or server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

As used and described herein, a user interface and a display and/or input device may output information in a format perceptible by a user and receive input from the user, e.g., the display and/or input device 418. The interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The interface may include an acoustic element such as a speaker, a microphone, and so forth. The interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by elements of the tongue weight sensing system 300. For example, inputs indicated as being received in a method may be input at the user interface 304 and/or received at the VCU 110. Determinations made in the methods may be outputs generated by the processing device 406 based on information, instructions, and/or inputs stored in the memory device 404. Outputs generated in the methods may be output to the user interface 304. In general, data described in the methods may be stored and/or processed by various elements of the tongue weight sensing system 300.

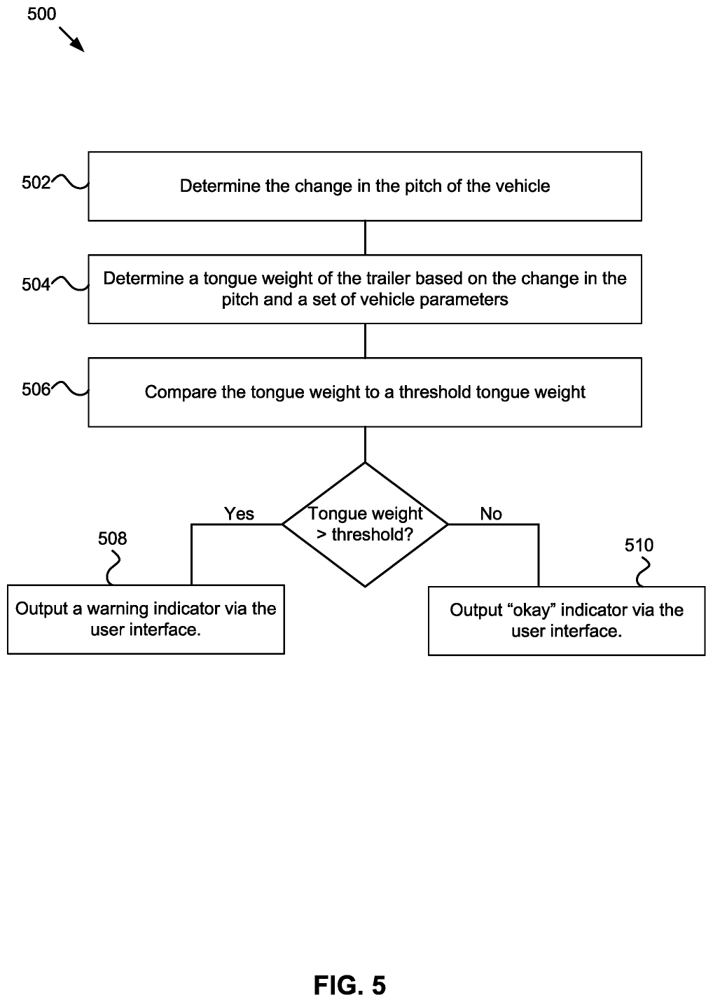

FIG. 5 illustrates a method 500 of determining and using a tongue weight, according to one embodiment. The method 500 may, for example, be executed by the VCU 110. The method 500 may be executed by the cloud-based data management and processing system 302. At block 502, a change in a pitch of a vehicle may be determined in response to detecting a signal from an accelerometer. The change in the pitch may be determined from a series of signals output by the accelerometer. For example, the series of signals may be a series of voltage outputs by the accelerometer. Changes in the voltage output of the accelerometer may correspond to a changing pitch of the vehicle. Various sampling rates may be used to ensure proper precision of the pitch change measurement. The sampling rate may be in a range from 200 Hertz to 1000 Hertz, from 300 Hertz to 800 Hertz, or from 400 Hertz to 600 Hertz. In some embodiments, the sampling rate may be 500 Hertz.

At block 504, the force exerted on the vehicle may be determined based on the change in the pitch. The force may, for example, be a tongue weight of a trailer attached to the vehicle. The tongue weight may further be determined based on a set of vehicle parameters. The vehicle parameters may include a position of the trailer hitch on the vehicle, the wheelbase, a stiffness of a rear suspension of the vehicle, and/or a stiffness of a front suspension of the vehicle.

At block 506 the tongue weight may be compared to a threshold tongue weight. The threshold tongue weight may represent a maximum tongue weight for the vehicle. At block 508, an output may be determined based on that comparison. For example, in response to the tongue weight being greater than the threshold tongue weight, a warning indicator may be output. The warning indicator may, for example, be output to a user interface or a user device, such as the user interface 304. The warning indicator may be output to a smartphone. the warning indicator may be output via a vehicle display in the passenger compartment. In response to the tongue weight being less than the threshold tongue weight, an indicator may be generated that indicates to a user the tongue weight is less than the limit. The tongue weight may also or alternatively be output to the user device. For example, the tongue weight may be output as a number in a particular color. Green may indicate the tongue weight is less than the limit. Red may indicate the tongue weight is over the limit for the vehicle.

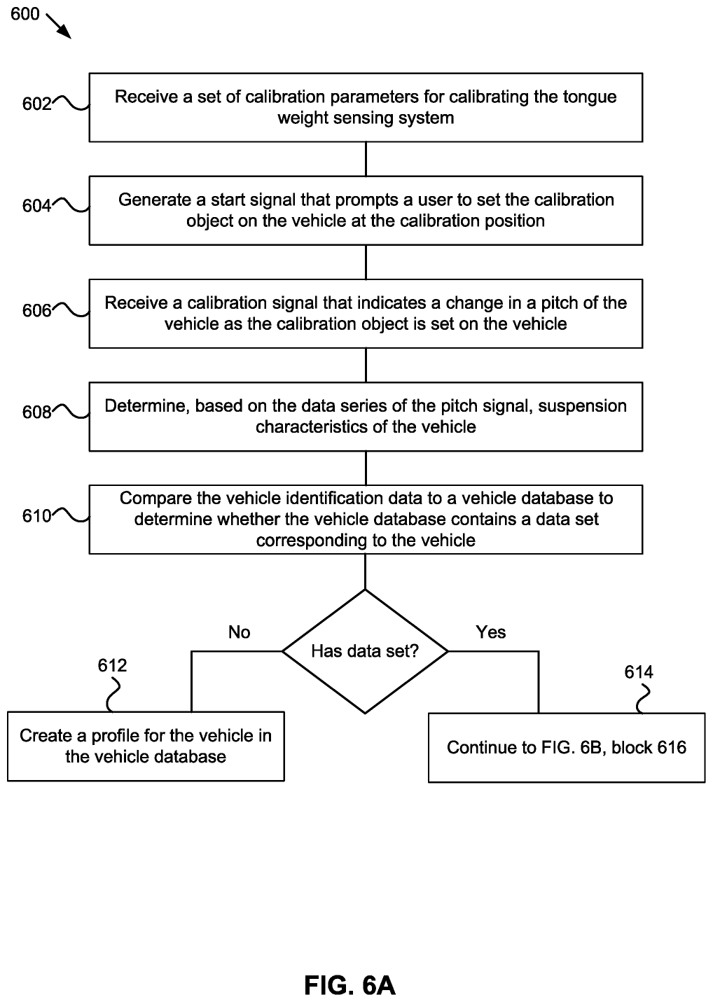

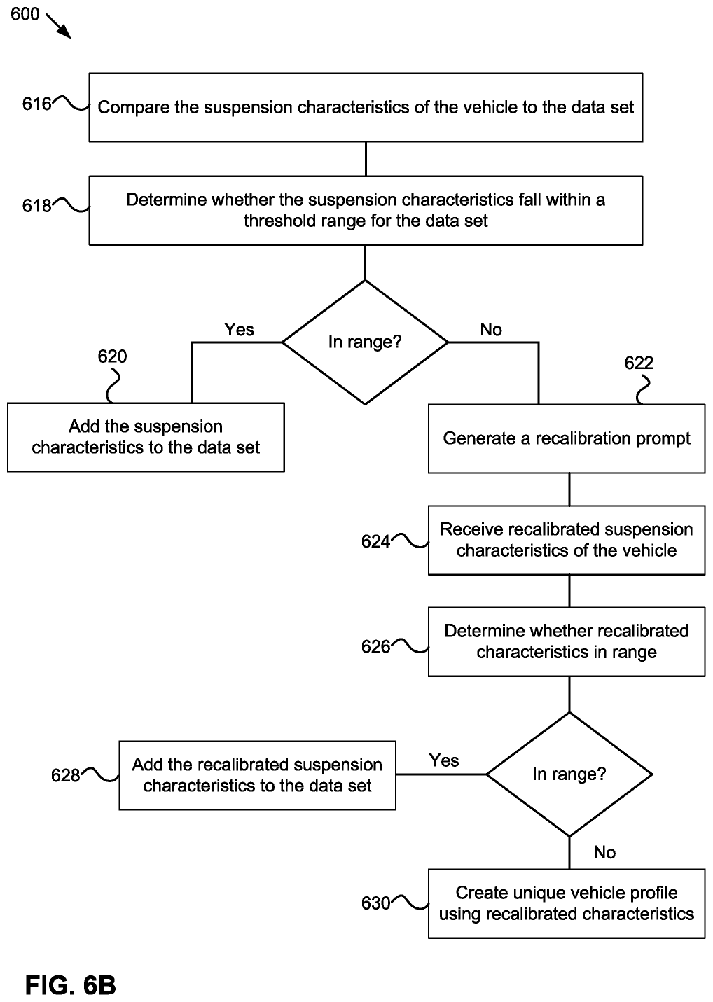

FIGS. 6A-B illustrate a method 600 of crowdsourcing calibration parameters for a tongue weight sensing system, according to one embodiment. The crowd sourced information may, for example, be stored in the database 308. The information may be accessed through the application programming interface 306 by a smart phone or the VCU 110. In some cases, the suspension characteristics of a vehicle may be published by the vehicles manufacturer and may be associated with the vehicle make, model, and year. A vehicle's identification number (VIN) may be associated with the make, model, and year of vehicle. Thus, the suspension characteristics of a particular vehicle may be found using the VIN. However, such published data may not account for aftermarket parts installed on the vehicle and/or wear and tear on the vehicle's suspension from use. Crowd sourcing suspension characteristics for particular vehicles based on make, model, and year may confirm published values and/or May allow more precise values to be calculated. For example, suspension characteristics of a vehicle may be determined based on its age and how recently components of the suspension were serviced or replaced.

At block 602, the method 600 may include receiving, via a user interface, a set of calibration parameters for calibrating the tongue weight sensing system. The calibration parameters may, for example, include the vehicle's particular VIN. The calibration parameters may, for example, include other identifying information, such as the make, model, and/or year of the vehicle. The calibration parameters may include a weight of a calibration object. The calibration object may be set on the vehicle so that the response of the vehicle's suspension can be measured using the accelerometer. The calibration parameters may include a calibration position. The calibration position may be a position on the vehicle where the calibration object will be set on the vehicle. In various embodiments, the calibration object may be a person. This may be useful because a person typically knows their weight. Additionally, a person typically weighs enough to cause a large enough change in a pitch of the vehicle that the reaction of the suspension can be accurately measured. In various embodiments, the calibration position may be on the bumper, in the bed of a truck, or on a tailgate.

At block 604, the method 600 may include generating a start signal that prompts the user to set the calibration object on the vehicle at the calibration position. A user may initiate calibration using their smart phone. For example, a user may have installed on their smart phone an application that provides visual instructions on calibrating the tongue weight sensing system. The smart phone may be communicatively coupled to the VCU and/or the vehicle's accelerometer. The application may instruct the user to initiate calibration. upon initiation, the application may begin collecting data from the vehicle's accelerometer. The application may instruct the user to sit or stand on the calibration position on the vehicle. the application may collect data from the accelerometer for a period of time, such as from when calibration is initiated until a stable state is detected from the accelerometer.

At block 606, the method 600 may include receiving, from the accelerometer, a calibration signal that indicates a change in a pitch of the vehicle as the calibration object is set on the vehicle. The pitch signal may include a data series corresponding to the changing pitch, such as a series of voltage readings from the accelerometer during the calibration period. At block 608, the method 600 may include determining, based on the data series of the pitch signal, suspension characteristics of the vehicle, the suspension characteristics may include a stiffness of the suspension, a natural frequency of the suspension, and/or a damper of the suspension.

At block 610, the method 600 may include comparing the vehicle identification data to a vehicle database to determine whether the vehicle database contains a data set corresponding to the vehicle. The data set may, for example, include crowdsourced data. The data set may be a crowdsourced data set. The data set may, for example, include information published by vehicle manufacturers. In response to determining that the vehicle database does not contain a data set corresponding to the vehicle, the method 600 may include, at block 612, creating A profile for the vehicle in the vehicle database. The profile for the vehicle may be correlated to the make, model, and year of the vehicle. The particular VIN used to create the profile may also be associated with the profile. In response to the vehicle database containing a dated set corresponding to the vehicle, the method 600 may proceed, at block 614, to comparing the measured data to the data stored in the database.

At block 616, the method 600 may include comparing the suspension characteristics determined from the accelerometer output to the characteristics stored in the data set for the vehicle type. At block 618, the method 600 may include determining whether the measured suspension characteristics fall within a threshold range for the data set. The threshold range may, for example, be a variance from a mean value for the suspension characteristic. The threshold range may be set such that, outside the threshold range, the measured suspension characteristic has a statistically significant difference from the crowdsourced data set and/or the values published by the manufacturer.

At block 620, the method 600 may include adding the suspension characteristics determined from the output of the accelerometer to the data set in response to the suspension characteristics being within the threshold range. The statistics of the data set may be updated based on the newly added suspension characteristics.

At block 622, the method 600 may include generating a recalibration prompt in response to the measured suspension characteristics falling outside the threshold range. The prompt may, for example, be a signal to a user output via a user device by which the user understands recalibration is needed. At block 624, the method 600 may include receiving recalibrated suspension characteristics of the vehicle. At block 626, the method 600 may include determining whether the recalibrated suspension characteristics fall within the threshold range for the data set. At block 628, the method 600 may include adding the re calibrated suspension characteristics to the data set in response to the recalibrated suspension characteristics being within the threshold range. At block 630, in response to the recalibrated suspension characteristics falling outside the threshold range, the method 600 may include creating a unique vehicle profile. The unique vehicle profile may include the recalibrated suspension characteristics. The unique vehicle profile may be unique to the particular vehicle from which this suspension characteristics were measured. The unique vehicle profile may, for example, be associated with the VIN.

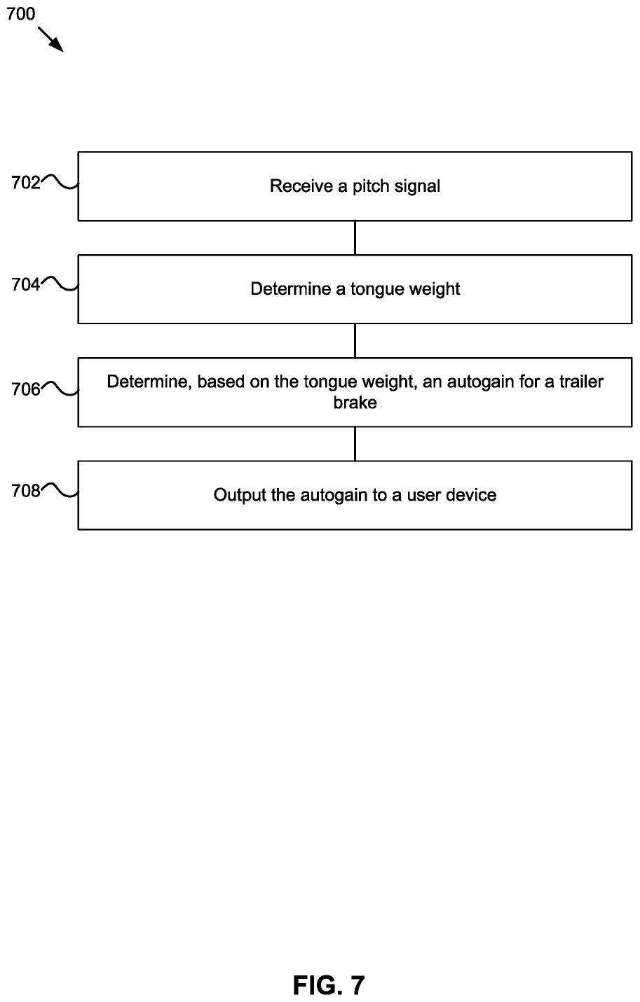

FIG. 7 illustrates a method 700 of setting a trailer brake autogain, according to one embodiment. At block 702, the method 700 may include receiving, from the accelerometer, a pitch signal. At block 704, the method 700 may include determining a tongue weight based on the data set corresponding to the vehicle and the pitch signal. At block 706, the method 700 may include determining, based on the tongue weight, an autogain for a trailer brake. The trailer brake may, for example, be the trailer brake of the trailer having the tongue weight measured by the accelerometer. The autogain may be determined using, for example, one of the methods described in U.S. Pat. No. 10,994,715, entitled “Auto Gain Adjusting Trailer Brake Controller,” the contents of which are incorporated herein in their entirety. At block 708, the method 700 may include outputting the auto gain. The auto gain may be output to a trailer brake controller. The auto game may be output to a user device such as a smartphone.

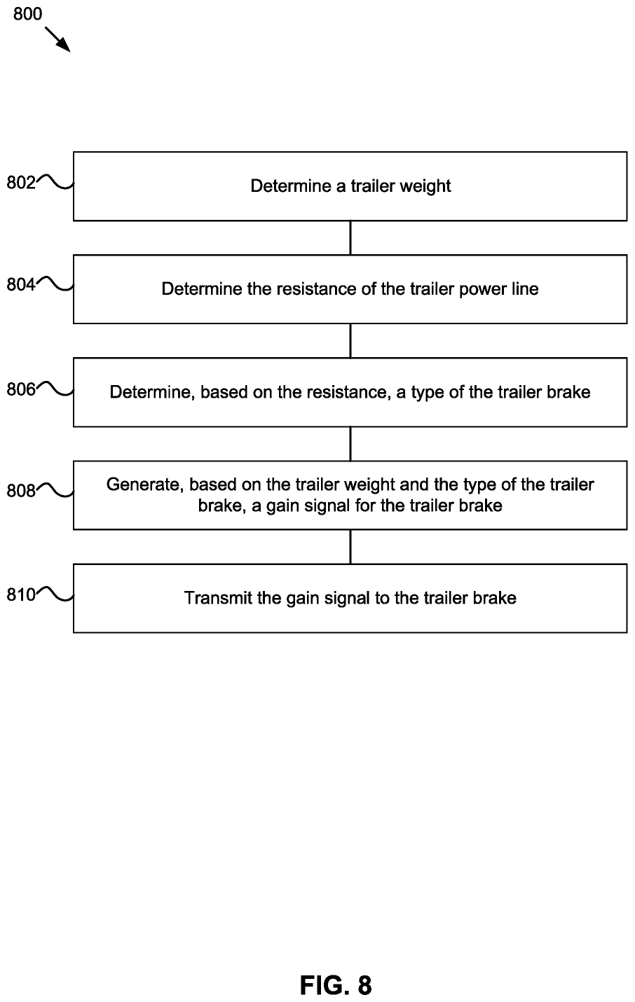

FIG. 8 illustrates a method 800 of generating a gain signal for a trailer brake, according to one embodiment. At block 802, the method 800 may include determining a trailer weight. The trailer weight may be determined based at least in part on a tongue weight of the trailer. A user may be prompted to select how a payload of the trailer is distributed, a length of the trailer, and other characteristics of the trailer. The trailer weight may be determined based on the tongue weight and the information input by the user. At block 804, the method 800 may include determining, based on a signal output by a power analyzer, the impedance of the trailer power line.

At block 806, the method 800 may include determining, based on the impedance, a type of the trailer brake on the trailer, preferably make and model. For example, the impedance may be transmitted to a user device and or a cloud-based data processing system. The impedance may be compared against a set of impedances for various types of trailer brakes. The type of the trailer brake may be communicated to the VCU or a trailer brake controller. The type may be stored in memory on the VCU or the trailer brake controller. At block 808, the method 800 may include generating, based on the trailer weight and the type of the trailer brake, a gain signal for the trailer break. At block 810, the method 800 may include transmitting the gain signal to the trailer brake.

With the make and model of the trailer brake identified, the system can also be used to diagnose the performance of the trailer brakes. This is done by using the engine signals from the vehicle and the Engine force model from a database. From the CAN (Controller Area Network) signals from the vehicle for engine speed and vehicle speed are derived. The trailer brake controller can determine the trailer braking force during a driving calibration procedure. Preferably, this is accomplished by driving forward slowly in a straight line while the trailer brake controller lightly applies the trailer brakes. By comparing the trailer braking force to expected value for the specific model of brake with the actual force applied, the performance of the trailer brakes is checked. Preferably, the system alerts the user if the braking force is outside of an acceptable range. For example, if the brake force is too low, the user is advised to have the brakes serviced. If the braking force is too high, the brakes can be checked for lockup and serviced accordingly.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several embodiments. It will be apparent to one skilled in the art, however, that at least some embodiments may be practiced without these specific details. In other instances, well-known components or methods are not described in detail or are presented in simple block diagram format in order to avoid unnecessarily obscuring the present embodiments. Thus, the specific details set forth above are merely exemplary. Particular embodiments may vary from these exemplary details and still be contemplated to be within the scope of the present embodiments.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower, or equal in scope to the original claims, are to be considered within the subject matter of the examples described herein.

The invention has been described with reference to various specific and preferred embodiments and techniques. Nevertheless, it is understood that many variations and modifications may be made while remaining within the spirit and scope of the invention.

What is claimed is:

1. A vehicle, comprising:
a passenger compartment wherein a passenger of the vehicle sits to operate the vehicle;
one or more vehicle controls in the passenger compartment whereby the passenger operates the vehicle;
a user interface in the passenger compartment positioned to be visible by the passenger;
a trailer hitch towards a rear end of the vehicle;
an accelerometer that outputs a signal in response to a change in a pitch of the vehicle as a trailer is attached to the vehicle at the trailer hitch, wherein the accelerometer is positioned:
in the passenger compartment;
behind a dashboard of the passenger compartment; or
towards the rear end of the vehicle and closer to the trailer hitch than the dashboard; and
a vehicle control unit (VCU) electronically or communicatively coupled to the accelerometer, the VCU comprising:
a memory device having computer-readable instructions stored thereon; and
a processing device electronically or communicatively coupled to the memory device that executes the instructions, wherein, as the processing device executes the instructions, it:
determines the change in the pitch of the vehicle in response to detecting the signal from the accelerometer, wherein the change in the pitch of the vehicle is caused by a trailer being attached to the trailer hitch;
determines a tongue weight of the trailer based on the change in the pitch and a set of vehicle parameters, wherein the set of vehicle parameters comprises:
a position of the trailer hitch on the vehicle; and
a stiffness of a rear and a front suspension of the vehicle;
compares the tongue weight to a threshold tongue weight, wherein the threshold tongue weight represents a maximum tongue weight for the vehicle; and
in response to the tongue weight being greater than the threshold tongue weight, outputs a warning indicator via the user interface.

2. The vehicle of claim 1, wherein the position of the trailer hitch is at a rear bumper of the vehicle.

3. The vehicle of claim 1, wherein the position of the trailer hitch is behind a rear axle of the vehicle.

4. The vehicle of claim 1, wherein the position of the trailer hitch is above a rear axle of the vehicle.

5. The vehicle of claim 1, wherein the set of vehicle parameters further comprises a payload of the vehicle.

6. The vehicle of claim 1, wherein a sampling rate of the accelerometer is greater than or equal to 500 hz.

7. The vehicle of claim 1, wherein the user interface is integrated into the dashboard of the vehicle.

8. A method of calibrating a tongue weight sensing system, comprising:
receiving, via a user interface, a set of calibration parameters for calibrating the tongue weight sensing system, the calibration parameters comprising:
vehicle identification data for a vehicle with which the tongue weight sensing system is used, wherein the vehicle identification data comprises one or more of:
a vehicle identification number;
a make of the vehicle;
a model of the vehicle; and
a year of the vehicle;
a weight of a calibration object used to calibrate the tongue weight sensing system; and
a calibration position on the vehicle where the calibration object will be set on the vehicle;
generating a start signal that prompts a user to set the calibration object on the vehicle at the calibration position;
receiving, from an accelerometer attached to the vehicle, a calibration signal that indicates a change in a pitch of the vehicle as the calibration object is set on the vehicle, wherein the pitch signal comprises a data series corresponding to the change in the pitch;
determining, based on the data series of the pitch signal, suspension characteristics of the vehicle, wherein the suspension characteristics comprise one or more of:
a stiffness of a suspension of the vehicle;
a natural frequency of the suspension; and
a damper of the suspension;
comparing the vehicle identification data to a vehicle database to determine whether the vehicle database contains a data set corresponding to the vehicle;
in response to the vehicle database containing the data set corresponding to the vehicle:
comparing the suspension characteristics of the vehicle to the data set;
determining whether the suspension characteristics fall within a threshold range for the data set;
in response to the suspension characteristics of the vehicle being within the threshold range, adding the suspension characteristics to the data set; and
in response to the suspension characteristics falling outside the threshold range:
generating a recalibration signal that prompts the user to recalibrate the tongue weight sensing system;
receiving recalibrated suspension characteristics of the vehicle;
determining whether the recalibrated suspension characteristics fall within the threshold range for the data set;
in response to the recalibrated suspension characteristics of vehicle being within the threshold range, adding the recalibrated suspension characteristics to the data set;
in response to the recalibrated suspension characteristics falling outside the threshold range, creating a unique vehicle profile comprising the recalibrated suspension characteristics, wherein the unique vehicle profile is unique to the vehicle;
in response to the vehicle database not containing the data set corresponding to the vehicle, creating a profile for the vehicle in the vehicle database, wherein the profile for the vehicle is correlated to the make, the model, and the year of the vehicle.

9. The method of claim 8, wherein the calibration object is a person, and the weight of the calibration object is a weight of the person.

10. The method of claim 8, wherein the calibration position is on a rear bumper or a tailgate of the vehicle.

11. The method of claim 8, wherein the data set corresponding to the vehicle is a crowdsourced data set.

12. The method of claim 8, further comprising:
receiving, from the accelerometer, a pitch signal;
determining a tongue weight of a trailer attached to the vehicle based on the data set corresponding to the vehicle and the pitch signal; and
outputting the tongue weight to a user device.

13. The method of claim 12, wherein determining the tongue weight of the trailer is further based on a hitching position on the vehicle where the trailer is hitched to the vehicle.

14. The method of claim 8, further comprising:
receiving, from the accelerometer, a pitch signal;
determining a tongue weight based on the data set corresponding to the vehicle and the pitch signal;
determining, based on the tongue weight, an autogain for a trailer brake; and
outputting the autogain to a user device.

15. A system that determines an autogain for a trailer brake, comprising:
a trailer wire connector that couples a vehicle electrical system to a trailer power line;
a power analyzer electrically coupled to the trailer wire connector, wherein the power analyzer measures a impedance from the trailer power line;
a vehicle control unit (VCU) electronically or communicatively coupled to the power analyzer, the VCU comprising:
a memory device having computer-readable instructions stored thereon; and
a processing device electronically or communicatively coupled to the memory device that executes the instructions, wherein, as the processing device executes the instructions, it:
determines a trailer weight;
determines, based on a signal output by the power analyzer, the impedance of the trailer power line;
determines, based on the impedance, a type of the trailer brake;
generates, based on the trailer weight and the type of the trailer brake, a gain signal for the trailer brake; and
transmits the gain signal to the trailer brake via the trailer wire connector.

16. The system of claim 15, further comprising an accelerometer, wherein:
the accelerometer is electronically or communicatively coupled to the VCU; and
the trailer weight is determined based on an output of the accelerometer.

17. The system of claim 16, wherein the type of the trailer brake is further determined from a database that stores impedance values correlated to trailer brake types.

18. The system of claim 16, wherein, to determine the type of the trailer brake, as the processing device executes the instructions, it:
transmits the impedance to a user device communicatively coupled to the VCU;
receives the type of the trailer brake from the user device; and
saves the type of the trailer brake in the memory device.

19. The system of claim 16, wherein the trailer weight is further determined based on a comparison of the output of the accelerometer to a suspension characteristic of a vehicle with which the system is used.

20. The system of claim 16, wherein the trailer weight is further determined based on a hitching position on a vehicle with which the system is used.
